(19) United States
(12) Patent Application Publication
(10) Pub. No.: US 2013/0264452 A1
(43) Pub. Date: Oct. 10, 2013

(54) FLY FORM TABLE WITH ADJUSTABLE LEGS

(71) Applicant: Peter Vanagan, Delta (CA)

(72) Inventor: Peter Vanagan, Delta (CA)

(21) Appl. No.: 13/860,258

(22) Filed: Apr. 10, 2013

Related U.S. Application Data
(60) Provisional application No. 61/622,439, filed on Apr. 10, 2012.

(51) Int. Cl. F16M 11/32; E04G 21/16

(52) U.S. Cl. CPC F16M 11/32; E04G 21/167
USPC 248/422

(57) ABSTRACT

A fly form table truss comprises a first chord and a second chord. A plurality of web members extend between the first chord and the second chord. The fly form table truss also has a plurality of legs. Each of the legs is connected to a corresponding one of the web members. Each of the leg members includes a telescoping member and a screw jack. The screw jack is hingedly coupled to the telescoping member. The web members may be A-frame members and may be movable longitudinally along the first chord and the second chord.

### CROSS-REFERENCE TO RELATED APPLICATION

This application claims the benefit of provisional application 61/622,439 filed in the United States Patent and Trademark Office on Apr. 10, 2012, the disclosure of which is incorporated herein by reference and priority to which is claimed.

### BACKGROUND OF THE INVENTION

1. Field of the Invention

The present invention relates to a fly form table and, in particular, to a fly form table truss with adjustable legs.

2. Description of the Related Art

U.S. Pat. No. 4,831,797 which issued on May 23, 1989 to the present inventor, then known as Vladikovic, and the full disclosure of which is incorporated herein by reference, discloses a fly form table truss. The fly form table truss includes a bottom chord and a top chord which are positioned generally parallel and spaced a distance apart. There is a plurality of substantially rigid web members spaced along and extending between the chords. The web members have first and second ends which are releasably connected with respective releasable fastening means to the chords. The fastening means permits longitudinal adjustment of the web members along the chords. The spacing between the first and second ends of the web members is essentially constant at any position of the web members along the chords.

U.S. Pat. No. 5,560,160 which issued on Oct. 1, 1996 to the present inventor, then known as Vladikovic, and the full disclosure of which is incorporated herein by reference, discloses a fly form table truss. The fly form table truss has web members interconnecting a bottom chord and a top chord. There are screw jack legs adjustable independently of the web members along the bottom chord. Each screw jack leg has a screw jack and a ground engagement member at one end of the screw jack leg, and is connected by a pivot connection to a readily releasable fastening mechanism provided at the opposite end of the screw jack for securing the screw jack leg to the bottom chord. The fastening mechanism comprises at least one fastener for tightening the fastening mechanism against the bottom chord to secure the screw jack leg in position on the bottom chord.

### SUMMARY OF THE INVENTION

There is provided a fly form table truss comprising a first chord and a second chord. A plurality of web members extend between the first chord and the second chord.

The fly form table truss also has a plurality of legs. Each of the legs is connected to a corresponding one of the web members. Each of the leg members includes a telescoping member and a screw jack. The screw jack may be hingedly coupled to the telescoping member. The web members may be releasably secured to the first chord and releasably secured to the second chord to thereby allow the web members to be selectively positioned longitudinally along the first chord and the second chord. The web members may be A-frame members and may be movable longitudinally along the first chord and the second chord. There is also provided a fly form table comprising the above described fly form table truss.

### BRIEF DESCRIPTIONS OF DRAWINGS

The invention will be more readily understood from the following description of the embodiments thereof given, by way of example only, with reference to the accompanying drawings, in which:

FIG. 1 is a perspective view of an improved fly form table;

FIG. 2 is a side elevation view of a truss of the fly form table of FIG. 1 showing legs of the truss in a retracted position;

FIG. 3 is a side elevation view of the truss of the fly form table of FIG. 1 showing legs of the truss in an extended position;

FIG. 4 is a side elevation view of an A-frame and a leg of the fly form table of FIG. 1 showing the leg in a retracted position;

FIG. 5 is a side elevation view of an A-frame and a leg of the fly form table of FIG. 1 showing the leg in an extended position;

FIG. 6 is an end elevation view of the fly form table of FIG. 1 showing legs of the truss in a retracted position;

FIG. 7 is an end elevation view of the fly form table of FIG. 1 showing legs of the truss in an extended position; and

FIG. 8 is an end elevation view of the fly form table of FIG. 1 showing screw jacks of the truss legs extending generally perpendicular to corresponding telescoping members of the truss legs.

### DESCRIPTIONS OF THE PREFERRED EMBODIMENTS

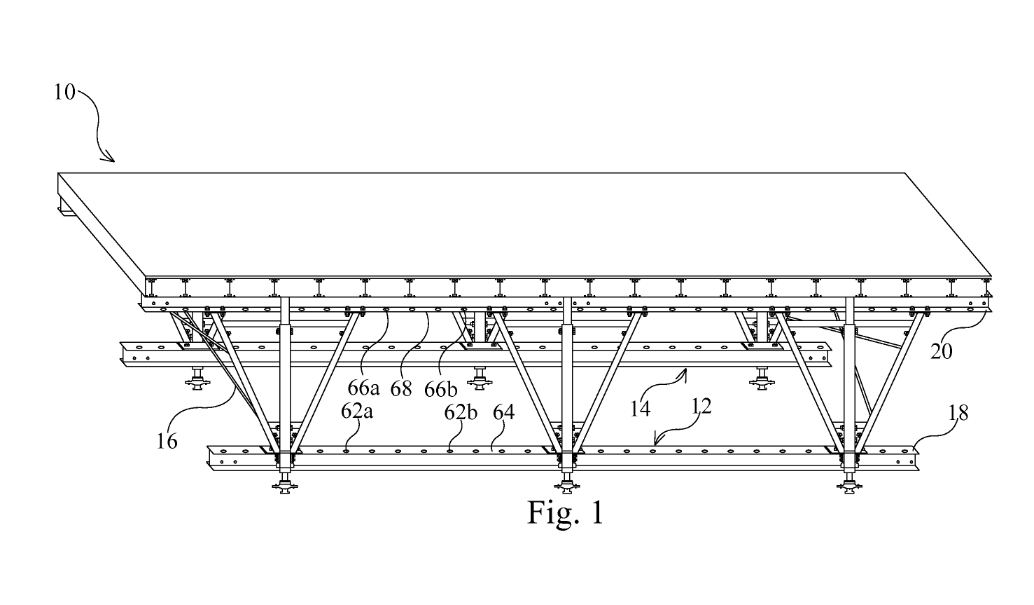

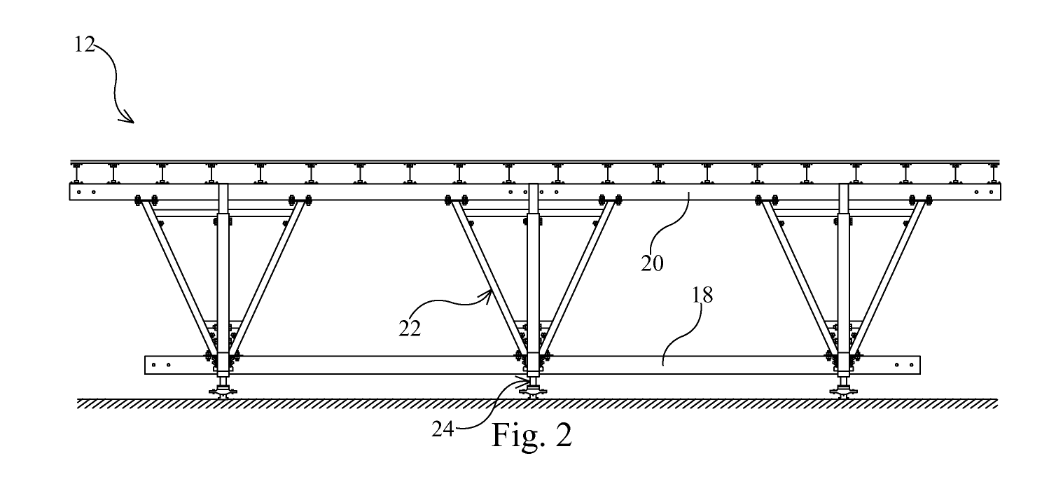

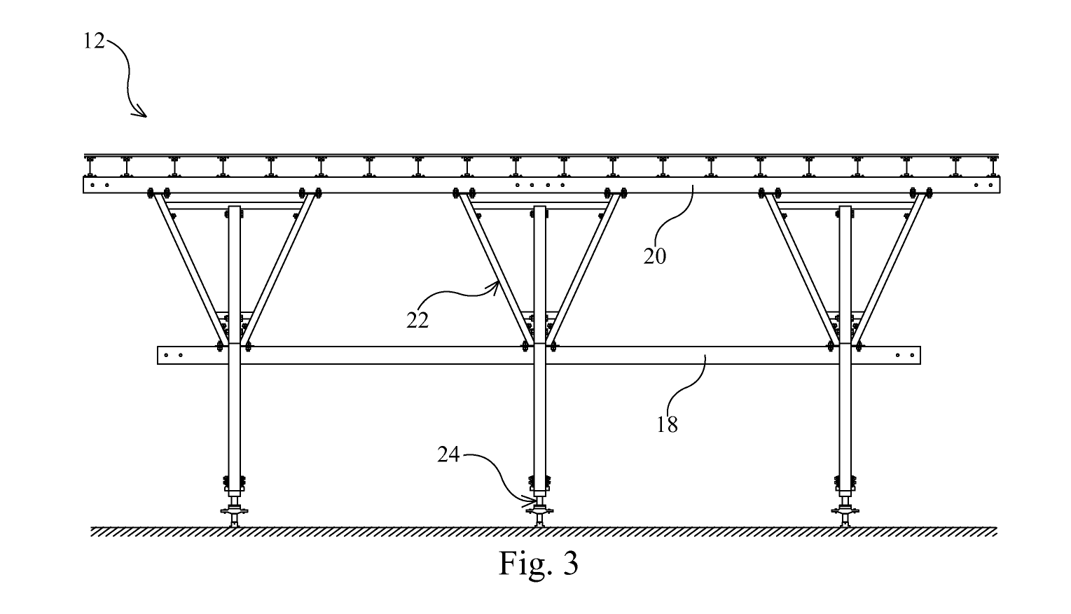

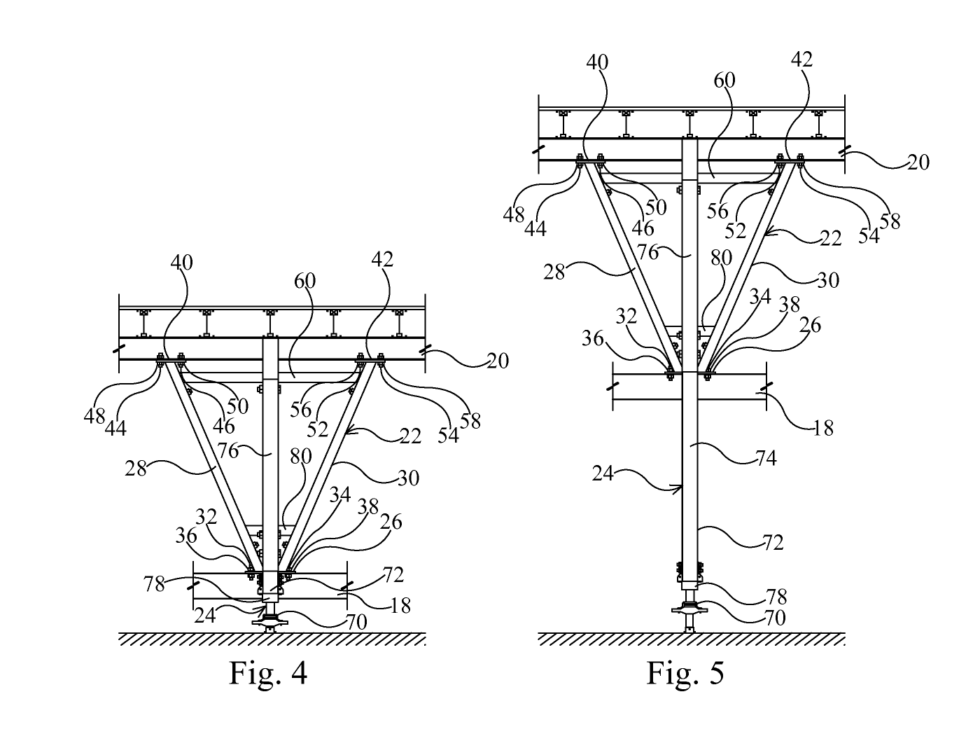

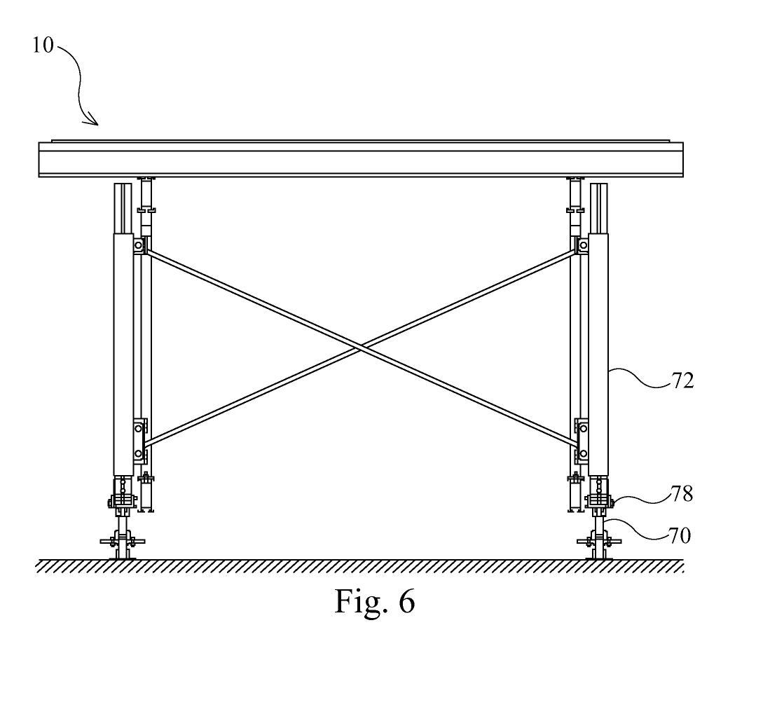

Referring to the drawings and first to FIG. 1 this shows an improved fly form table 10. The fly form table 10 includes a pair of parallel trusses 12 and 14 which are connected together by braces, for example brace 16, as shown in FIG. 1. Only a first one of the trusses 12 is described in detail herein with the understanding that a second one of the trusses 14 has a substantially identical structure and functions in a substantially identical manner. The first truss 12, which is shown in greater detail in FIGS. 2 and 3, includes a first or bottom chord 18 and a second or top chord 20. The bottom chord 18 and the top chord 20 are generally parallel and web members, for example A-frame 22, extend between the bottom chord 18 and top chord 20. Each of the A-frames is connected to a corresponding leg, for example, leg 24 as shown for A-frame 22. The A-frame 22 and the leg 24 are shown in greater detail in FIGS. 4 and 5.

The A-frame 22 includes a bottom chord mounting plate 26 from which two angularly spaced frame members 28 and 30 extend. The bottom chord mounting plate 26 is releasably secured to the bottom chord 18 by threaded members in the form of bolts 32 and 34 which are secured in place by corresponding nuts 36 and 38. Each of the frame members 28 and 30 has a respective top chord mounting plate 40 and 42. The top chord mounting plate 40 of a first one of the frame members 28 is releasably secured to the top chord 20 by threaded members in the form of bolts 44 and 46 which are secured in place by nuts 48 and 50. Likewise the top chord mounting plate 42 of a second one of the frame members 30 is releasably secured to the top chord 20 by threaded members in the form of bolts 52 and 54 which are secured in place by nuts 56 and 58. There is also a cross brace 60 extending between the angularly spaced frame members 28 and 30.

As shown in FIG. 1 there is a plurality of spaced-apart apertures, for example apertures 62a and 62b, extending through a flange 64 of the bottom chord 18.

There is also a plurality of spaced-apart apertures, for example apertures 66a and 66b, extending through a flange 68 of the top chord 20. The spaced-apart apertures in the chords allow the A-frames to be selectively positioned longitudinally along the bottom and top chords when assembling the fly form table 10. The A-frames may also be moved longitudinally along the bottom and top chords in response to load requirements. This may be accomplished by unbolting the A-frames from the bottom and top chords at a first position, sliding the A-frames longitudinally along the bottom and top chords to a second position, and bolting the A-frames to the bottom and top chords at the second position.

Referring back to FIGS. 4 and 5, the leg 24 includes a screw jack 70 and telescoping member 72 which are best shown in FIG. 5. The telescoping member 72 has an inner tubular member 74 which is reciprocatingly received by an outer tubular member 76. The screw jack 70 is movable between a retracted position, shown in FIG. 4, and an extended position shown in FIG. 5. The telescoping member 72 is also movable between a retracted position, shown in FIG. 4, and an extended position shown in FIG. 5. This allows the fly form table 10, shown in FIG. 1, to accommodate different floor to ceiling heights with the screw jack 70 allowing for fine height adjustment. The screw jack 70 is hingedly coupled to the telescoping member 72 by a coupling mechanism 78. The telescoping member 72 is secured to the cross brace 60 and a mounting plate 80 disposed between the angularly spaced frame members 28 and 30.

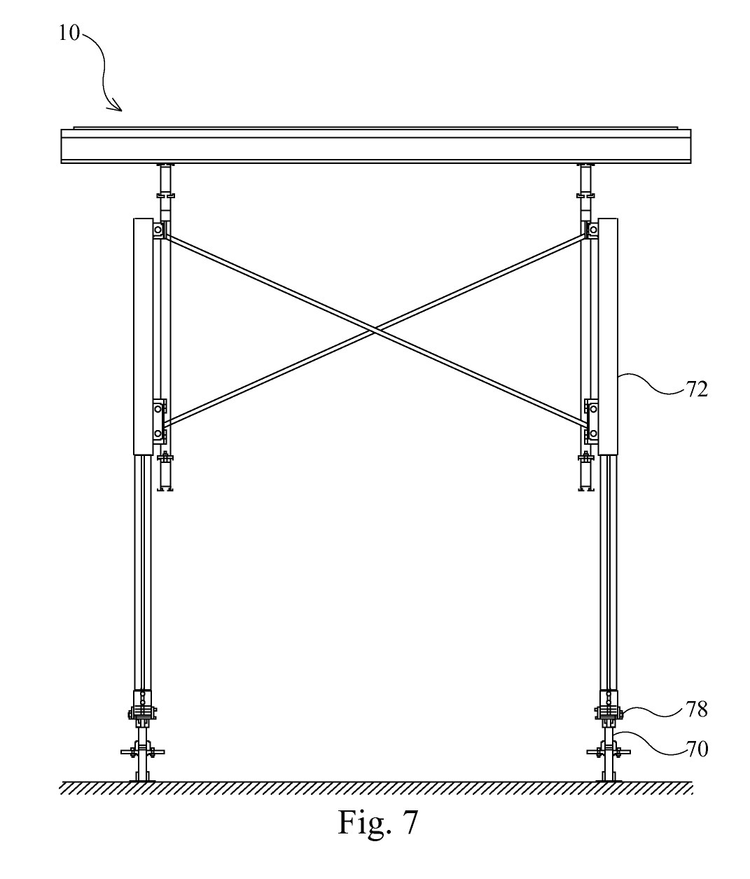

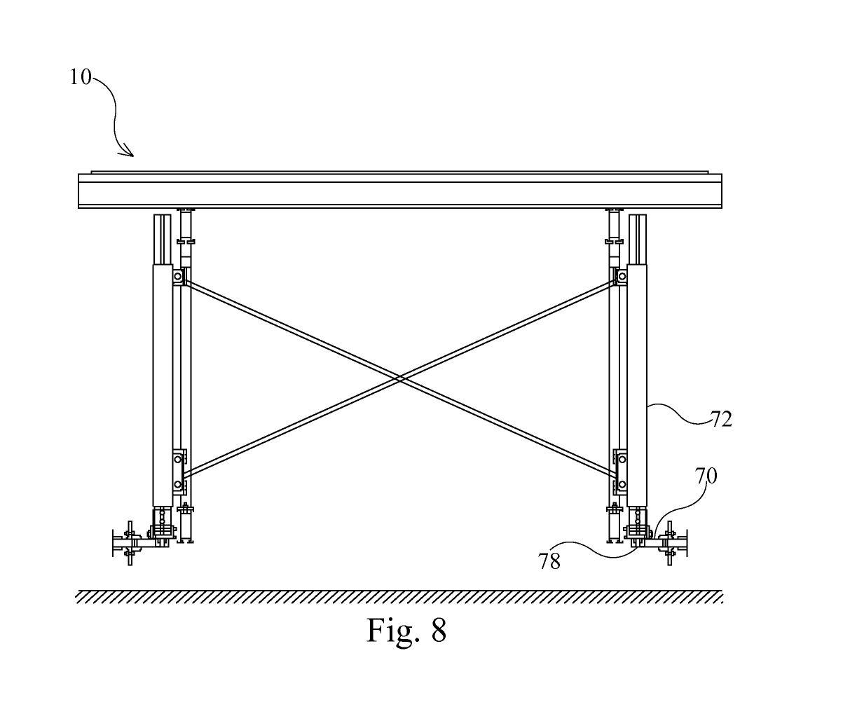

The screw jack 70 is movable between a first position in which the screw jack 70 is substantially co-axial with the telescoping member 72, as shown in FIGS. 6 and 7, and a second position in which the screw jack is substantially perpendicular with the telescoping member 72 as shown in FIG. 8. Moving the screw jack 70 to the second position allows the fly form table 10 to be lowered onto rollers (not shown) and pushed out from under a slab. In particular, moving the screw jack 70 to the second position allows bottom surfaces of the bottom chords to glide freely over the rollers.

It will be understood by a person skilled in the art that many of the details provided above are by way of example only, and are not intended to limit the scope of the invention which is to be determined with reference to the following claims.

What is claimed is:

1. A fly form table truss comprising:
a first chord and a second chord;
a plurality of web members extending between the first chord and the second chord; and
a plurality of legs, each of the legs being connected to a corresponding one of the web members, and each of the legs including a telescoping member and a screw jack.

2. The fly form table truss as claimed in claim 1 wherein the screw jack is hingedly coupled to the telescoping member.

3. The fly form table truss as claimed in claim 1 wherein the web members are releasably secured to the first chord and releasably secured to the second chord to thereby allow the web members to be selectively positioned longitudinally along the first chord and the second chord.

4. The fly form table truss as claimed in claim 1 wherein the web members are A-frame members which are movable longitudinally along the first chord and the second chord.

5. A fly form table truss comprising:
a first chord and a second chord;
a plurality of web members extending between the first chord and the second chord, each of the web members being releasably secured to the first chord and releasably connected to the second chord to thereby allow the web members to be selectively positioned longitudinally along the first chord and the second chord; and
a plurality of legs, each of the legs being connected to a corresponding once of the web members, and each of the legs including a telescoping member and a screw jack hingedly coupled to the telescoping member.

6. The fly form table truss as claimed in claim 5 wherein the web members are A-frame members

7. A fly form table comprising a fly form table truss, the fly form table truss including:
a first chord and a second chord;
a plurality of web members extending between the first chord and the second chord; and
a plurality of legs, each of the legs being connected to a corresponding one of the web members, and each of the legs including a telescoping member and a screw jack.

8. The fly form table truss as claimed in claim 7 wherein the screw jack is hingedly coupled to the telescoping member.

9. The fly form table truss as claimed in claim 7 wherein the web members are releasably secured to the first chord and releasably secured to the second chord to thereby allow the web members to be selectively positioned longitudinally along the first chord and the second chord.

10. The fly form table truss as claimed in claim 7 wherein the web members are A-frame members which are movable longitudinally along the first chord and the second chord.
